(19) United States
(12) Patent Application Publication
(10) Pub. No.: US 2018/0124114 A1
(43) Pub. Date: May 3, 2018

(54) APPARATUS AND METHOD FOR SUPPORTING USE OF DYNAMIC RULES IN CYBER-SECURITY RISK MANAGEMENT

(71) Applicant: Honeywell International Inc., Morris Plains, NJ (US)

(72) Inventors: Scott A. Woods, Cave Creek, AZ (US); Seth G. Carpenter, Phoenix, AZ (US); Kenneth W. Dietrich, Glendale, AZ (US); Seth P. Heywood, Gilbert, AZ (US)

(21) Appl. No.: 15/724,109

(22) Filed: Oct. 3, 2017

Related U.S. Application Data
(60) Provisional application No. 62/413,860, filed on Oct. 27, 2016.

(51) Int. Cl. H04L 29/06; G06F 21/57; G06F 3/0484; G06F 3/0482; G06F 3/0481

(52) U.S. Cl. CPC H04L 63/20; G06F 21/577; H04L 63/1416; G06F 3/04812; G06F 3/0484; G06F 3/0482; H04L 63/1433

(57) ABSTRACT

A method includes obtaining information defining a custom rule from a user. The custom rule is associated with a cyber-security risk. The custom rule identifies a type of cyber-security risk associated with the custom rule and information to be used to discover whether the cyber-security risk is present in one or more devices or systems of an industrial process control and automation system. The method also includes providing information associated with the custom rule for collection of information related to the custom rule from the one or more devices or systems. The method further includes analyzing the collected information related to the custom rule to identify at least one risk score associated with the one or more devices or systems and/or the industrial process control and automation system. In addition, the method includes presenting the at least one risk score or information based on the at least one risk score.

### CROSS-REFERENCE TO RELATED APPLICATION AND PRIORITY CLAIM

This application claims priority under 35 U.S.C. § 119(e) to U.S. Provisional Patent Application No. 62/413,860 filed on Oct. 27, 2016. This provisional application is hereby incorporated by reference in its entirety.

### TECHNICAL FIELD

This disclosure relates generally to computing and networking security. More specifically, this disclosure relates to an apparatus and method for supporting the use of dynamic rules in cyber-security risk management.

### BACKGROUND

Processing facilities are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern. Unaddressed security vulnerabilities in any of these components could be exploited by attackers to disrupt operations or cause unsafe conditions in an industrial facility.

### SUMMARY

This disclosure provides an apparatus and method for supporting the use of dynamic rules in cyber-security risk management.

In a first embodiment, a method includes obtaining information defining a custom rule from a user. The custom rule is associated with a cyber-security risk. The custom rule identifies a type of cyber-security risk associated with the custom rule and information to be used to discover whether the cyber-security risk is present in one or more devices or systems of an industrial process control and automation system. The method also includes providing information associated with the custom rule for collection of information related to the custom rule from the one or more devices or systems. The method further includes analyzing the collected information related to the custom rule to identify at least one risk score associated with at least one of: the one or more devices or systems and the industrial process control and automation system. In addition, the method includes presenting the at least one risk score or information based on the at least one risk score.

In a second embodiment, an apparatus includes at least one memory configured to store information defining a custom rule from a user. The custom rule is associated with a cyber-security risk. The custom rule identifies a type of cyber-security risk associated with the custom rule and information to be used to discover whether the cyber-security risk is present in one or more devices or systems of an industrial process control and automation system. The apparatus also includes at least one processing device configured to provide information associated with the custom rule for collection of information related to the custom rule from the one or more devices or systems. The at least one processing device is further configured to analyze the collected information related to the custom rule to identify at least one risk score associated with at least one of: the one or more devices or systems and the industrial process control and automation system. In addition, the at least one processing device is configured to present the at least one risk score or information based on the at least one risk score.

In a third embodiment, a non-transitory computer readable medium contains instructions that, when executed by at least one processing device, cause the at least one processing device to obtain information defining a custom rule from a user. The custom rule is associated with a cyber-security risk. The custom rule identifies a type of cyber-security risk associated with the custom rule and information to be used to discover whether the cyber-security risk is present in one or more devices or systems of an industrial process control and automation system. The medium also contains instructions that, when executed by the at least one processing device, cause the at least one processing device to provide information associated with the custom rule for collection of information related to the custom rule from the one or more devices or systems. The medium further contains instructions that, when executed by the at least one processing device, cause the at least one processing device to analyze the collected information related to the custom rule to identify at least one risk score associated with at least one of: the one or more devices or systems and the industrial process control and automation system. In addition, the medium contains instructions that, when executed by the at least one processing device, cause the at least one processing device to present the at least one risk score or information based on the at least one risk score.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example device used in conjunction with an industrial process control and automation system according to this disclosure;

FIGS. 3 through 9 illustrate an example graphical user interface supporting the use of dynamic rules in cyber-security risk management according to this disclosure;

FIG. 10 illustrates an example data flow supporting the use of dynamic rules in cyber-security risk management according to this disclosure; and

FIG. 11 illustrates an example method for supporting the use of dynamic rules in cyber-security risk management according to this disclosure.

### DETAILED DESCRIPTION

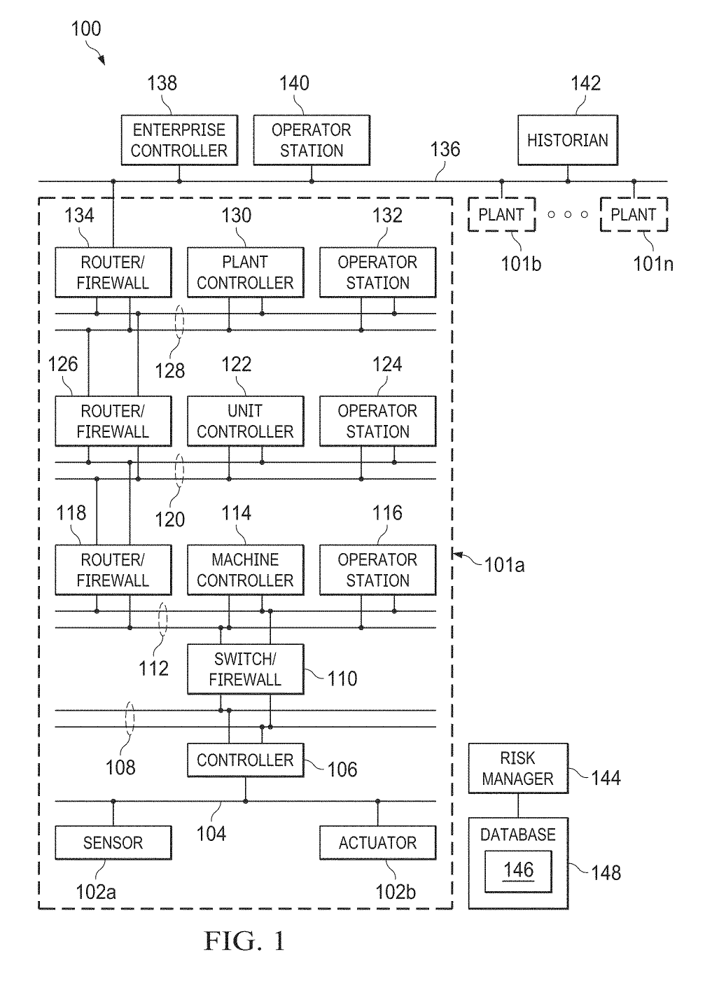

FIGS. 1 through 11, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 142 can be coupled to the network 136. The historian 142 could represent a component that stores various information about the system 100. The historian 142 could, for instance, store information used during process control, production scheduling, and optimization operations. The historian 142 represents any suitable structure for storing and facilitating retrieval of information. Although shown as a single centralized component coupled to the network 136, the historian 142 could be located elsewhere in the system 100, or multiple historians could be distributed in different locations in the system 100 and used to store common or different data.

In particular embodiments, the various controllers and operator stations in FIG. 1 may represent computing devices. For example, each of the controllers and operator stations could include one or more processing devices; one or more memories storing instructions and data used, generated, or collected by the processing device(s); and at least one network interface, such as one or more Ethernet interfaces or wireless transceivers.

As noted above, cyber-security is of increasing concern with respect to industrial process control and automation systems. For example, unaddressed security vulnerabilities in any of the components in the system 100 could be exploited by attackers to disrupt operations or cause unsafe conditions in an industrial facility. In industrial environments, it is often difficult to quickly determine the potential sources of cyber-security risks to the whole system. Modern control systems contain a mix of servers, workstations, switches, routers, firewalls, safety systems, proprietary real-time controllers, and field devices. Often times, these components are a mixture of equipment from different vendors.

In accordance with this disclosure, a risk manager 144 can monitor the various devices in an industrial process control and automation system, identify cyber-security related issues with the devices, and provide information to plant operators about the cyber-security related issues. The risk manager 144 operates using rules 146, which can be stored in a database 148. The rules 146 define the cyber-security issues that the risk manager 144 searches for and how important those cyber-security issues are. The risk manager 144 can use the rules 146 to identify known cyber-security related issues in the industrial process control and automation system 100 and to generate indicators for the identified cyber-security related issues. The rules 146 could also define how the risk manager 144 reacts when those cyber-security related issues are identified.

The risk manager 144 includes any suitable structure for identifying cyber-security issues in an industrial process control and automation system. For example, the risk manager 144 could denote a computing device that executes instructions implementing the risk management functionality of the risk manager 144. As a particular example, the risk manager 144 could be implemented using the INDUSTRIAL CYBER SECURITY RISK MANAGER software platform from HONEYWELL INTERNATIONAL INC. The database 148 includes any suitable structure for storing and facilitating retrieval of information.

Conventional cyber-security tools are often implemented using a “push” model such that rules are pushed from an external system to a cyber-security tool, which scans computing or networking devices or systems based on the rules. While effective in some instances (such as with conventional virus-scanning tools used by the general public), this typically does not permit end-users to scan for cyber-security related issues using their own business knowledge of a particular domain or their own cyber-security expertise.

In accordance with this disclosure, the risk manager 144 supports the creation, management, and use of dynamic rules 146 by the risk manager 144. The dynamic rules 146 allow users to create, manage, and use custom rules “on the fly” to search devices and systems for specific properties (such as specific files, versions, or registry entries). Once defined, dynamic rules 146 can be distributed by the risk manager 144 to connected devices being monitored by the risk manager 144 so that local agents on those devices can implement the rules 146. Using data from the connected devices, the risk manager 144 can generate at least one cyber-security risk score based on the collected information, including information related to the monitored properties of the connected devices. The risk scores could identify the cyber-security risk levels for specific devices in an industrial process control and automation system or the cyber-security risk level of the overall control and automation system.

In some embodiments, the dynamic rules 146 can supplement or replace existing default rules of the risk manager 144. For example, the risk manager 144 could, by default, have access to rules for each type of threat or vulnerability that has been identified by a vendor, supplier, or other party associated with the risk manager 144. These default rules could come with the installation of the risk manager 144 or be updated into the risk manager 144 and might not be removable. The ability to define new rules 146 dynamically allows the creation and use of rules that fit a particular user's needs, and those rules 146 could in some instances override the default rules. The user can also customize, delete, import, or export dynamically-created rules 146 as needed. The ability to import and export rules 146 may allow, for instance, dynamic rules to be created and shared among multiple sites, such as in different plants 101a-101n.

By taking inputs of areas and attributes to search for from a user, the risk manager 144 supports custom data collection to gather information and report that information to a calculation engine of the risk manager 144. The calculation engine includes that custom information in the calculation of the risk score(s). In this way, users are allowed to create custom rules 146 based on their own business knowledge or cyber-security expertise. Risk scores identifying risks to devices or systems can be calculated using inputs obtained via those custom rules 146. As a result, users can specify guidance and baseline risk scores from a cyber-security perspective to help a site respond to a positive discovery of specific cyber-security related issues.

In some embodiments, the risk manager 144 supports a form-based approach through which a user is able to create a rule 146 and set an impact (risk score) to that rule 146. The risk manager 144 then uses its calculation engine to take the rule 146 into account, such as when calculating an overall site risk score. Additional details regarding the creation, management, and use of custom rules 146 with a risk manager 144 are provided below.

Although FIG. 1 illustrates one example of an industrial process control and automation system 100, various changes may be made to FIG. 1. For example, a control system could include any number of sensors, actuators, controllers, operator stations, networks, risk managers, databases, and other components. Also, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, process control and automation systems are highly configurable and can be configured in any suitable manner according to particular needs. In addition, FIG. 1 illustrates one example environment in which the use of dynamic rules in cyber-security risk management can be supported. This functionality can be used in any other suitable device or system.

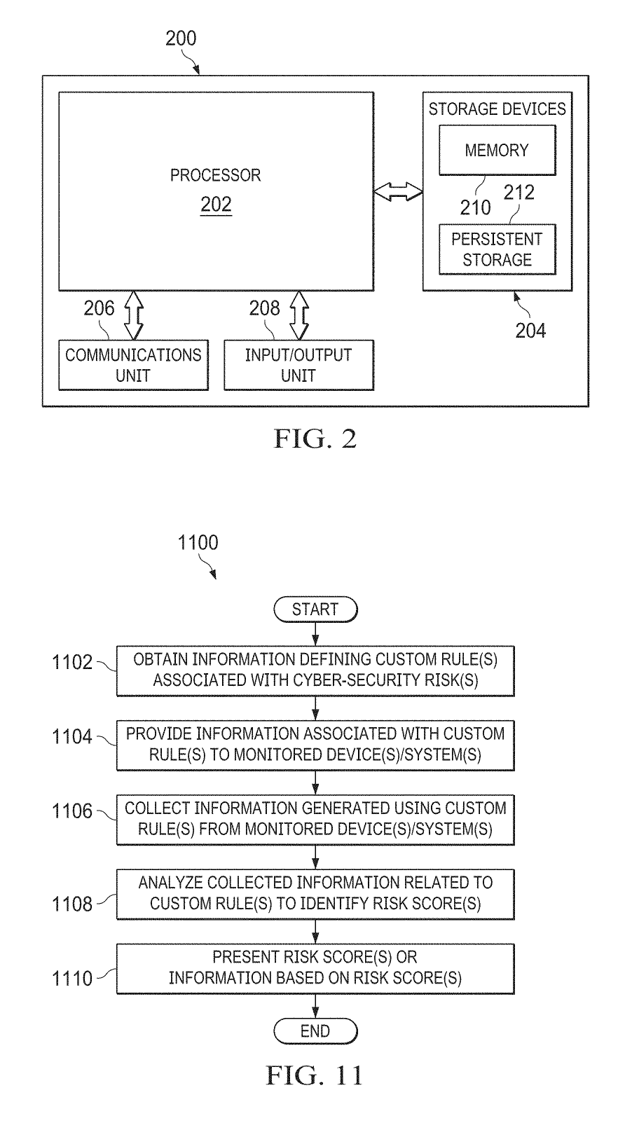

FIG. 2 illustrates an example device 200 used in conjunction with an industrial process control and automation system according to this disclosure. The device 200 could, for example, represent the risk manager 144 in FIG. 1. However, the device 200 could be used in any other suitable system, and the risk manager 144 could be implemented using any other suitable device.

As shown in FIG. 2, the device 200 includes at least one processing device 202, at least one storage device 204, at least one communications unit 206, and at least one input/output (I/O) unit 208. The processing device 202 executes instructions that may be loaded into a memory 210. The processing device 202 may include any suitable number(s) and type(s) of processors or other devices in any suitable arrangement. Example types of processing devices 202 include microprocessors, microcontrollers, digital signal processors, field programmable gate arrays, application specific integrated circuits, and discrete logic devices.

The memory device 210 and a persistent storage 212 are examples of storage devices 204, which represent any structure(s) capable of storing and facilitating retrieval of information (such as data, program code, and/or other suitable information on a temporary or permanent basis). The memory device 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include a network interface card or a wireless transceiver facilitating communications over a wired or wireless network. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device.

Although FIG. 2 illustrates one example of a device 200 used in conjunction with an industrial process control and automation system, various changes may be made to FIG. 2. For example, various components in FIG. 2 could be combined, further subdivided, rearranged, or omitted and additional components could be added according to particular needs. Also, computing devices can come in a wide variety of configurations, and FIG. 2 does not limit this disclosure to any particular configuration of computing device.

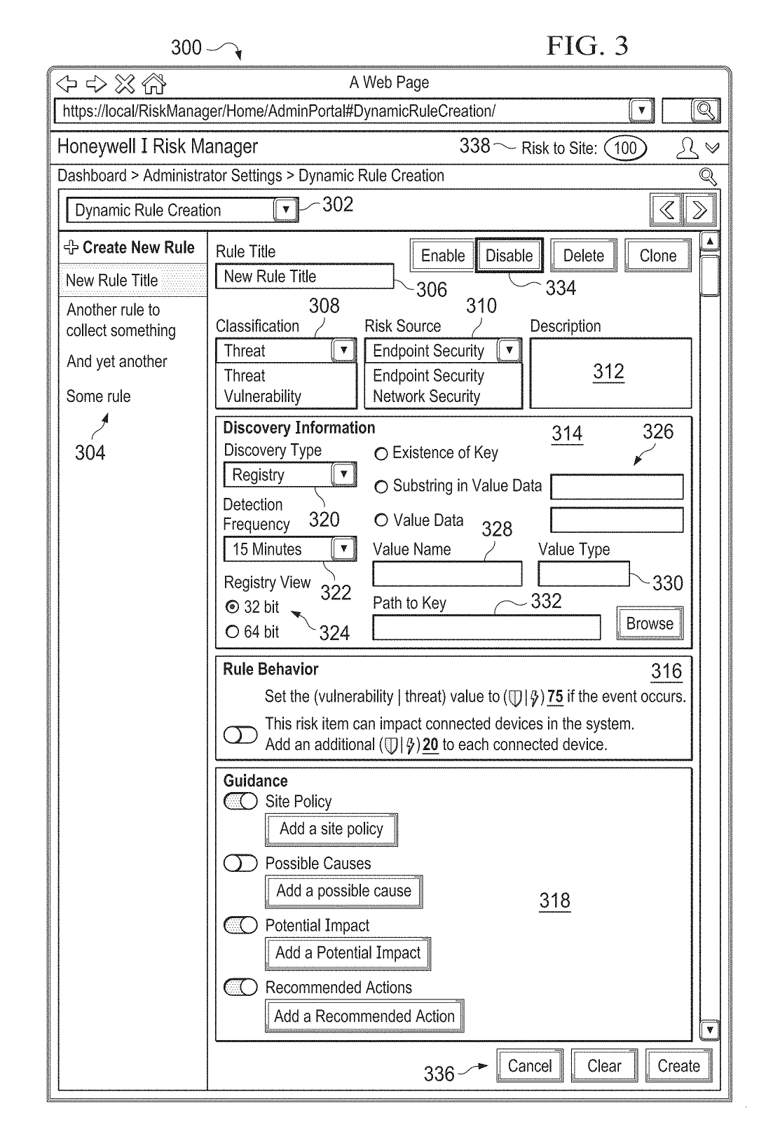

FIGS. 3 through 9 illustrate an example graphical user interface 300 supporting the use of dynamic rules in cyber-security risk management according to this disclosure. For ease of explanation, the graphical user interface 300 is described as being used by the risk manager 144 in the system 100 of FIG. 1. However, the risk manager 144 could use any other suitable interface, and the graphical user interface 300 could be used with devices in any other suitable system.

As noted above, dynamic rules 146 can be created to search computing or networking devices or systems for specific properties (such as specific files, versions, or registry entries). The graphical user interface 300 allows users to perform various functions related to the dynamic rules 146. For example, the graphical user interface 300 allows users to create rules 146 for specific threats and vulnerabilities. “Threats” relate to specific attacks on devices or systems, and “vulnerabilities” relate to potential avenues of attack on devices or systems.

The graphical user interface 300 also allows users to create both endpoint rules 146 and network rules 146. Endpoint rules 146 relate to properties of specific devices, and network rules 146 relate to properties of network communications. Of course, rules 146 that apply to multiple types of devices or multiple types of network communications could also or alternatively be used.

The graphical user interface 300 further allows users to customize how frequently a rule 146 is used to scan for a possible threat or vulnerability and to define which registry values, files, installed applications, events, or directories are searched for or examined. For example, a user could specify the interval at which a rule 146 is used, and the user could identify specific values or locations to be searched or examined. The graphical user interface 300 also allows users to customize the behaviors of the rules 146 in other ways (such as by specifying a decay, frequency, connected devices, and adjacency) and associated risk factors. For instance, a user could define a risk value that increases if repeat threats/vulnerabilities are detected in a given time period or that decreases if repeat threats/vulnerabilities are not detected in a given time period. The user could also define that risk values for devices connected to a specific device are increased if a threat/vulnerability is detected in the specified device.

Further, the graphical user interface 300 allows users to customize knowledge base items such as site policies, possible causes, potential impacts, and recommended actions when defining the rules 146. Site policies can denote overall policies used to manage cyber-security for a particular location. Possible causes, potential impacts, and recommended actions denote potential reasons for a cyber-security issue, potential effects if the cyber-security issue is exploited, and potential actions to reduce or eliminate the cyber-security issue. This information could be provided to users when threats or vulnerabilities are actually detected using the rules 146, and this information could help the users to lessen or resolve the threats or vulnerabilities.

In addition, the graphical user interface 300 allows users to (individually or in groups) enable and disable dynamic rules 146, delete dynamic rules 146, clone dynamic rules 146 to quickly create new rules 146 that are similar, and import and export dynamic rules 146. Separate dynamic rule pages can be supported to easily distinguish and maintain dynamically-created rules 146. For instance, separate dynamic rule pages could be used to define and maintain rules 146 for different locations, different industrial processes, or different types of equipment.

As shown in FIG. 3, the graphical user interface 300 includes a control 302 (a drop-down menu in this case) that allows a user to select an option for dynamic rule creation. Any additional option or options could be presented in the control 302, depending on what other functions could potentially be invoked by a user.

Once the option for dynamic rule creation is selected, a section 304 of the graphical user interface 300 allows the user to create a new dynamic rule or select a previously-created dynamic rule. In this example, a new dynamic rule can be created by selecting the “+Create New Rule” option, and any previously-created dynamic rules can be listed under the “+Create New Rule” option for selection by the user.

Whether a new rule is being created or an existing rule has been selected, the graphical user interface 300 allows the user to enter or revise a rule name in a text box 306. The graphical user interface 300 also allows the user to define a classification for the rule (such as whether the rule relates to a threat or a vulnerability) using a control 308 and to define a risk source for the rule (such as whether the rule relates to endpoint security or network security) using a control 310. Note that other or additional classifications and risk sources could also be supported. A text box 312 allows the user to enter or revise a longer description of the particular rule.

The graphical user interface 300 further includes a section 314 allowing the user to specify discovery information, a section 316 allowing the user to specify rule behavior, and a section 318 allowing the user to specify guidance information. The discovery information generally defines where a computing or networking device or system is examined to determine whether a cyber-security issue is present. A control 320 allows the user to select different types of cyber-security issues. The types of cyber-security issues could include those related to registries, files, directories, installed applications, or events. Of course, other or additional types of cyber-security issues could also be used. A control 322 allows the user to define how often to scan for a particular threat or vulnerability. For instance, the control 322 could allow the user to select from a number of predefined time intervals, enter a custom time interval, or identify one or more events, types of events, or other triggers that could initiate scanning.

In FIG. 3, the “registry” option has been selected, and the user can use other controls 324-332 to define a particular cyber-security issue related to a registry. In particular, the control 324 allows the user to define whether the registry is viewed using 32-bit or 64-bit values. The control 326 allows the user to control whether the registry-related cyber-security issue is defined as the existence of a particular registry entry, the presence of a substring in a registry entry, or the presence of a particular value as a registry entry. The presence or existence of different registry-related cyber-security issues could be detected using different registry entries and/or registry values. The controls 328 and 330 allow the user to define the registry entry's name and type, and the control 332 allows the user to define a pathway to the registry entry (possibly by browsing through a registry to locate the registry entry).

The rule behavior specified in section 316 of the graphical user interface 300 allows the user to control how a particular rule behaves or impacts other rules. For example, the user can define the risk value assigned to an event identified using the rule. The user could also define how the risk value decays over time if repeat events are not detected. The user could further define how the detection of an event identified using the rule could affect other rules.

The guidance information specified in section 318 of the graphical user interface 300 allows the user to associate site policies, possible causes, potential impacts, and recommended actions with a particular rule. There could be zero or more of each of the site policies, possible causes, potential impacts, and recommended actions associated with the rule.

Controls 334 in the graphical user interface 300 allow the user to enable, disable, delete, or clone a rule selected in section 304 of the graphical user interface 300. Controls 336 in the graphical user interface 300 allow the user to save the options entered in the graphical user interface 300, cancel without saving, or clear the user selections in the graphical user interface 300. A summary 338 in the graphical user interface 300 identifies a summary of the risk score(s) associated with a site, which could be selected to view the risk scores.

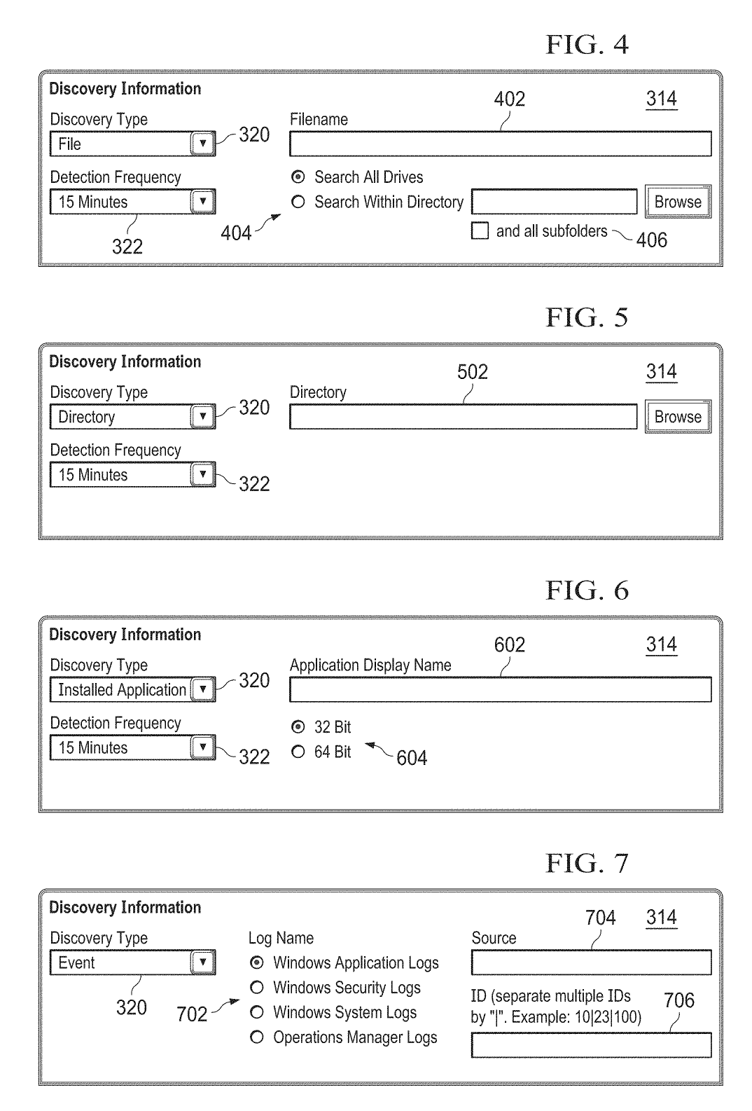

FIGS. 4 through 7 illustrate other implementations of the discovery information section 314 when different types of cyber-security issues are selected using the control 320. In FIG. 4, a “file” type of cyber-security issue has been selected using the control 320. Based on that selection, the discovery information section 314 includes a text box 402 in which the user can provide a specific filename, and wildcards (*) may or may not be allowed as part of the filename. The discovery information section 314 also includes a control 404 with which a user can control where the filename is scanned for, which in this case includes options for scanning all drives or for searching within a specified directory (which could possibly be identified by browsing). In addition, the discovery information section 314 includes a control 406 with which the user can control whether subdirectories of the identified directory are scanned (although this option could be disabled if the “search all drives” option is selected).

In FIG. 5, a “directory” type of cyber-security issue has been selected using the control 320. Based on that selection, the discovery information section 314 includes a text box 502 in which the user can identify a specific directory, or the user can select an existing directory by browsing.

In FIG. 6, an “installed application” type of cyber-security issue has been selected using the control 320. Based on that selection, the discovery information section 314 includes a text box 602 in which the user can identify a specific application name and a control 604 with which the user can define the application type. In some embodiments, a list of the applications installed on a device or in a system could be provided to the user for selection, or some other mechanism could be used to allow the user to select an existing installed application.

In FIG. 7, an “event” type of cyber-security issue has been selected using the control 320. Based on that selection, the discovery information section 314 includes a control 702 with which the user can specify the name/type of an event source. In this example, the control 702 identifies a number of different types of log files, although other log files or event sources could be used. The discovery information section 314 also includes a text box 704 in which the user can identify the name of an event source and a text box 706 in which the user can provide one or more event identifiers.

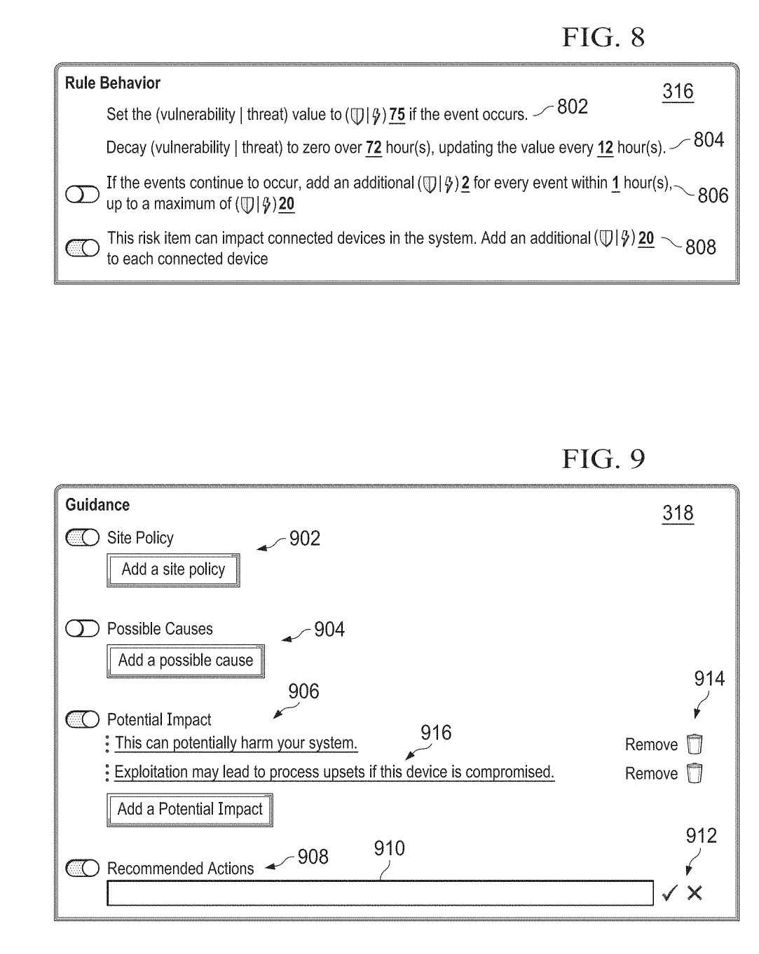

FIG. 8 illustrates example contents of the rule behavior section 316, all or a subset of which could be presented to the user in the graphical user interface 300. As shown in FIG. 8, a control 802 allows the user to specify a threat or vulnerability value that is assigned if an event for the particular rule occurs. The value that is defined here can be used by the risk manager 144 to perform various tasks, such as summarizing the various risks to devices or systems that have been detected using the rules 146. In some embodiments, the threat or vulnerability value could range between zero (no risk) to 100 (high risk), although other ranges of values could also be used.

A control 804 allows the user to decay the threat or vulnerability value over time if the event does not repeat within a specified time period. For example, the control 804 allows the user to define how the threat or vulnerability value defined using the control 802 drops to zero over a specified time period. The control 804 also allows the user to define a specified interval at which the threat or vulnerability value is updated. This may allow, for instance, the threat or vulnerability value of a cyber-security event to diminish in importance over time if the event is not repeated.

A control 806 allows the user to supplement or increase the threat or vulnerability value defined using the control 802 (up to some maximum value) if an event for the particular rule repeats within a specified time period. This may allow, for instance, the threat or vulnerability value of a cyber-security event to increase in importance over time if the event repeats. The control 806 can be selectively enabled or disabled for a rule since there may or may not be a need to increase the threat or vulnerability value for a rule.

A control 808 allows the user to specify whether a threat or vulnerability can impact other devices in a system. If so, the control 808 allows the user to specify how those devices' threat or vulnerability values can be supplemented. For example, if an event associated with the defined rule is detected, a threat or vulnerability value for any connected devices could be supplemented by a specified value. This could be useful, for instance, if a cyber-security threat in one device could be exploited in order to attack or otherwise affect any connected devices. The control 808 can be selectively enabled or disabled for a rule since there may or may not be a need to increase the threat or vulnerability values of connected devices for a rule.

FIG. 9 illustrates example contents of the guidance information section 318, all or a subset of which could be presented to the user in the graphical user interface 300. As shown in FIG. 9, a control 902 allows the user to identify whether at least one site policy is associated with a particular rule. A control 904 allows the user to identify whether at least one possible cause is associated with the particular rule. A control 906 allows the user to identify whether at least one potential impact is associated with the particular rule. A control 908 allows the user to identify whether at least one recommended action is associated with the particular rule. Each of the controls 902-908 could allow the user to select from a predefined or existing site policy/cause/impact/recommended action, or the user could be provided a text box 910 in which the user can provide text identifying the site policy/cause/impact/recommended action. Controls 912 allow the user to accept or reject the current text in the text box 910, and controls 914 allow the user to delete an existing site policy/cause/impact/recommended action. Any existing site policy/cause/impact/recommended action that has been selected or defined could be presented as a hyperlink 916, which could be selected by the user or other users to retrieve more information about the site policy/cause/impact/recommended action.

Although FIGS. 3 through 9 illustrate one example of a graphical user interface 300 supporting the use of dynamic rules in cyber-security risk management, various changes may be made to FIGS. 3 through 9. For example, the content and arrangement of the graphical user interface are for illustration only. Also, while specific input mechanisms (such as buttons, text boxes, and pull-down menus) are described above and shown in the figures, any suitable mechanisms can be used to obtain information from a user.

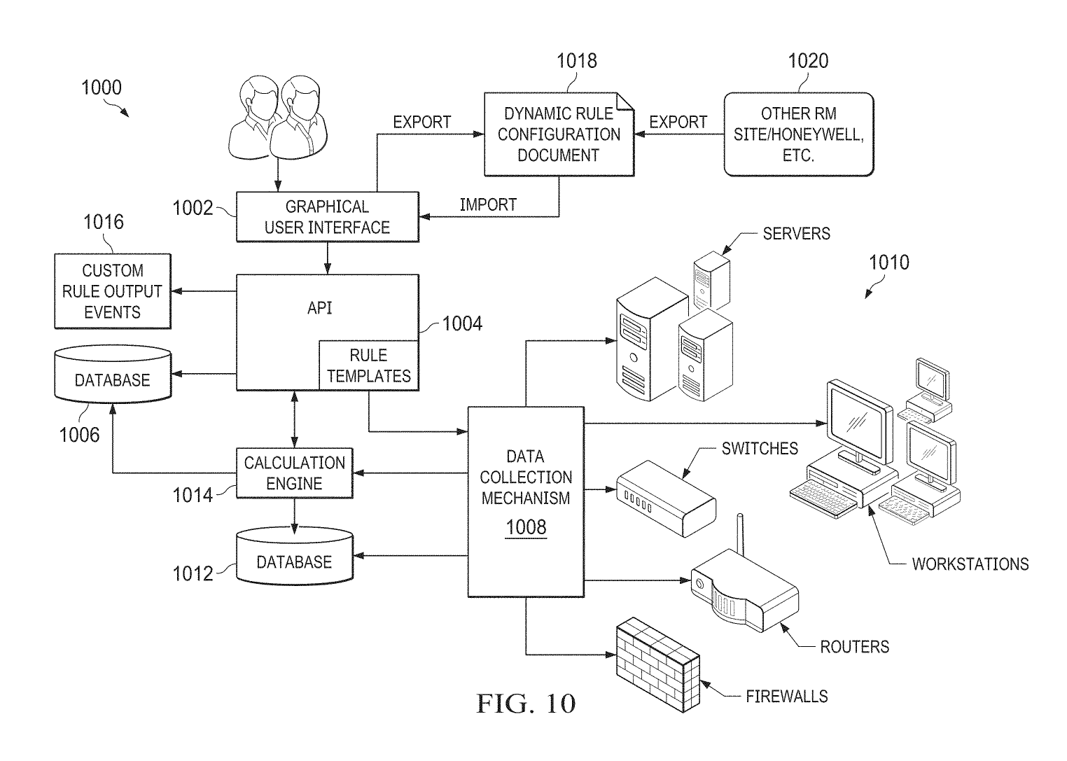

FIG. 10 illustrates an example data flow 1000 supporting the use of dynamic rules in cyber-security risk management according to this disclosure. The data flow 1000 could, for example, be implemented using the risk manager 144 and the database 148 described above. However, the data flow 1000 could be implemented in any other suitable manner.

As shown in FIG. 10, a user can enter data about dynamic rules through a graphical user interface 1002, which could denote the graphical user interface 300 shown in FIGS. 3 through 9 and described above. However, any other suitable graphical user interface(s) could be used to collect information about dynamic rules.

A web application programming interface (API) 1004 can receive the data and parse the data into custom rule templates. The data can be stored in a database 1006, and the rule templates (populated with the specifics of the rules defined by the user) are imported into a data collection mechanism 1008. The data collection mechanism 1008 could denote an application or service that deploys custom rules to devices 1010 that the user wants to monitor for discovery of data defined in the rules.

Data that is collected from the devices 1010 can be stored in a database 1012 and provided to a calculation engine 1014. The calculation engine 1014 uses the data and the defined rules to calculate risk scores associated with the rules and with the overall system. Risk scores or other information can be presented to users via a risk management website. The risk scores calculated here are based (at least in part) on the threat or vulnerability values assigned by the users to the rules 146.

Optionally, the data collected using custom rules can be output as events 1016, such as in a syslog or other log file or as part of a database or spreadsheet. Also, the graphical user interface 1002 can support the import and export of information about dynamic rules 146, such as in the form of dynamic rule configuration documents 1018. Imported dynamic rule configuration documents 1018 could be generated by any suitable source 1020, such as other risk management applications. As noted above, the import and export functions could allow dynamic rules 146 to be shared across multiple sites.

In some embodiments, the databases 1006 and 1012 shown in FIG. 10 could form the database 148 described above. Also, in some embodiments, other components 1002-1004, 1008, 1014 can be implemented within the risk manager 144, such as by using software or firmware programs. In particular embodiments, at least some of the other components 1002-1004, 1008, 1014 could be implemented using the INDUSTRIAL CYBER SECURITY RISK MANAGER software platform from HONEYWELL INTERNATIONAL INC.

Although FIG. 10 illustrates one example of a data flow 1000 supporting the use of dynamic rules in cyber-security risk management, various changes may be made to FIG. 10. For example, the risk manager 144 could be implemented in any other suitable manner and need not have the form shown in FIG. 10.

FIG. 11 illustrates an example method 1100 for supporting the use of dynamic rules in cyber-security risk management according to this disclosure. For ease of explanation, the method 1100 is described as being performed using the risk manager 144 of FIG. 1 implemented using the device 200 of FIG. 2. However, the method 1100 could be used with any other suitable device(s) and in any other suitable system(s).

As shown in FIG. 11, information defining at least one custom rule associated with at least one cyber-security risk is obtained from one or more users at step 1102. This could include, for example, the processing device 202 of the risk manager 144 initiating a display of the graphical user interface 300 and receiving information defining at least one custom rule 146 from a user via the graphical user interface 300. Each custom rule can identify a type of cyber-security risk associated with the custom rule and information to be used to discover whether the cyber-security risk is present in one or more devices or systems of an industrial process control and automation system. In some embodiments, the user can identify a classification (such as a threat or vulnerability), a risk source (such as an endpoint or a network), and a discovery type (such as a registry, a file, a directory, an installed application, or an event) for each rule through the graphical user interface 300. As particular examples, the user could specify one or more names of one or more items to be searched for in the devices or systems, one or more locations where the devices or systems are to be examined, or a frequency at which the devices or systems are to be examined for the cyber-security risk.

Information associated with each custom rule is provided to one or more devices or systems being monitored or to be monitored (referred to collectively monitored devices/systems) at step 1104. This could include, for example, the processing device 202 of the risk manager 144 initiating communication of the custom rules or information based on the custom rules to one or more local agents on one or more monitored devices/systems. The local agents could denote software applications that use the information associated with the custom rules 146 to scan for cyber-security risks on the monitored devices/systems.

Information generated using the custom rules is collected at step 1106. This could include, for example, the processing device 202 of the risk manager 144 receiving information from the one or more local agents on the one or more monitored devices/systems. The collected information could include one or more threat or vulnerability values generated in response to one or more actual cyber-security risks detected on the monitored devices/systems. The local agents or the risk manager 144 could also modify the threat or vulnerability values as described above. For instance, threat or vulnerability values could be decayed when repeat events are not detected or supplemented when repeat events are detected, or threat or vulnerability values could be supplemented for connected devices when an event is detected in a specified device.

The information generated using the custom rule(s) is analyzed to generate at least one risk score at step 1108, and the at least one risk score is presented at step 1110. This could include, for example, the processing device 202 of the risk manager 144 including the risk score in a graphical display, such as in the summary 338 of the graphical user interface 300. Each risk score could identify the overall cyber-security risk to the industrial process control and automation system or to a portion of the industrial process control and automation system. Each risk score could also be color-coded or use another indicator to identify a severity of the overall cyber-security risk.

Although FIG. 11 illustrates one example of a method 1100 for supporting the use of dynamic rules in cyber-security risk management, various changes may be made to FIG. 11. For example, while shown as a series of steps, various steps in FIG. 11 could overlap, occur in parallel, or occur any number of times.

Note that the risk manager 144 and/or the other processes, devices, and techniques described in this patent document could use or operate in conjunction with any single, combination, or all of various features described in the following previously-filed patent applications (all of which are hereby incorporated by reference):
U.S. patent application Ser. No. 14/482,888 (U.S. Patent Publication No. 2016/0070915) entitled “DYNAMIC QUANTIFICATION OF CYBER-SECURITY RISKS IN A CONTROL SYSTEM”;
U.S. patent application Ser. No. 14/669,980 (U.S. Patent Publication No. 2016/0050225) entitled “ANALYZING CYBER-SECURITY RISKS IN AN INDUSTRIAL CONTROL ENVIRONMENT”;
U.S. patent application Ser. No. 14/871,695 (U.S. Patent Publication No. 2016/0234240) entitled “RULES ENGINE FOR CONVERTING SYSTEM-RELATED CHARACTERISTICS AND EVENTS INTO CYBER-SECURITY RISK ASSESSMENT VALUES”;
U.S. patent application Ser. No. 14/871,521 (U.S. Patent Publication No. 2016/0234251) entitled “NOTIFICATION SUBSYSTEM FOR GENERATING CONSOLIDATED, FILTERED, AND RELEVANT SECURITY RISK-BASED NOTIFICATIONS”;
U.S. patent application Ser. No. 14/871,855 (U.S. Patent Publication No. 2016/0234243) entitled “TECHNIQUE FOR USING INFRASTRUCTURE MONITORING SOFTWARE TO COLLECT CYBER-SECURITY RISK DATA”;
U.S. patent application Ser. No. 14/871,732 (U.S. Patent Publication No. 2016/0234241) entitled “INFRASTRUCTURE MONITORING TOOL FOR COLLECTING INDUSTRIAL PROCESS CONTROL AND AUTOMATION SYSTEM RISK DATA”;
U.S. patent application Ser. No. 14/871,921 (U.S. Patent Publication No. 2016/0232359) entitled “PATCH MONITORING AND ANALYSIS”;
U.S. patent application Ser. No. 14/871,503 (U.S. Patent Publication No. 2016/0234229) entitled “APPARATUS AND METHOD FOR AUTOMATIC HANDLING OF CYBER-SECURITY RISK EVENTS”;
U.S. patent application Ser. No. 14/871,605 (U.S. Patent Publication No. 2016/0234252) entitled “APPARATUS AND METHOD FOR DYNAMIC CUSTOMIZATION OF CYBER-SECURITY RISK ITEM RULES”;
U.S. patent application Ser. No. 14/871,547 (U.S. Patent Publication No. 2016/0241583) entitled “RISK MANAGEMENT IN AN AIR-GAPPED ENVIRONMENT”;
U.S. patent application Ser. No. 14/871,814 (U.S. Patent Publication No. 2016/0234242) entitled “APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS”;
U.S. patent application Ser. No. 14/871,136 (U.S. Patent Publication No. 2016/0234239) entitled “APPARATUS AND METHOD FOR TYING CYBER-SECURITY RISK ANALYSIS TO COMMON RISK METHODOLOGIES AND RISK LEVELS”; and
U.S. patent application Ser. No. 14/705,379 (U.S. Patent Publication No. 2016/0330228) entitled “APPARATUS AND METHOD FOR ASSIGNING CYBER-SECURITY RISK CONSEQUENCES IN INDUSTRIAL PROCESS CONTROL ENVIRONMENTS”.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining information defining a custom rule from a user, the custom rule associated with a cyber-security risk, the custom rule identifying a type of cyber-security risk associated with the custom rule and information to be used to discover whether the cyber-security risk is present in one or more devices or systems of an industrial process control and automation system;
providing information associated with the custom rule for collection of information related to the custom rule from the one or more devices or systems;
analyzing the collected information related to the custom rule to identify at least one risk score associated with at least one of: the one or more devices or systems and the industrial process control and automation system; and
presenting the at least one risk score or information based on the at least one risk score.

2. The method of claim 1, wherein obtaining the information defining the custom rule comprises receiving the type of cyber-security risk associated with the custom rule from the user through a graphical user interface.

3. The method of claim 2, wherein receiving the type of cyber-security risk comprises receiving a classification, a risk source, and a discovery type from the user through the graphical user interface.

4. The method of claim 3, wherein:
the classification is one of a threat and a vulnerability;
the risk source is one of an endpoint and a network; and
the discovery type is one of a registry, a file, a directory, an installed application, and an event.

5. The method of claim 1, wherein obtaining the information to be used to discover whether the cyber-security risk is present in the one or more devices or systems comprises at least one of:
receiving one or more names of one or more items to be searched for in the one or more devices or systems from the user through a graphical user interface; and
receiving one or more locations where the one or more devices or systems are to be examined from the user through the graphical user interface.

6. The method of claim 1, wherein obtaining the information to be used to discover whether the cyber-security risk is present in the one or more devices or systems comprises receiving a frequency for which the one or more devices or systems are to be examined for the cyber-security risk.

7. The method of claim 1, further comprising at least one of:
exporting the custom rule; and
importing an additional custom rule.

8. An apparatus comprising:
at least one memory configured to store information defining a custom rule from a user, the custom rule associated with a cyber-security risk, the custom rule identifying a type of cyber-security risk associated with the custom rule and information to be used to discover whether the cyber-security risk is present in one or more devices or systems of an industrial process control and automation system; and
at least one processing device configured to:
provide information associated with the custom rule for collection of information related to the custom rule from the one or more devices or systems;
analyze the collected information related to the custom rule to identify at least one risk score associated with at least one of: the one or more devices or systems and the industrial process control and automation system; and
present the at least one risk score or information based on the at least one risk score.

9. The apparatus of claim 8, wherein the at least one processing device is configured to receive the type of cyber-security risk associated with the custom rule from the user through a graphical user interface.

10. The apparatus of claim 9, wherein the at least one processing device is configured to receive a classification, a risk source, and a discovery type from the user through the graphical user interface.

11. The apparatus of claim 10, wherein:
the classification is one of a threat and a vulnerability;
the risk source is one of an endpoint and a network; and
the discovery type is one of a registry, a file, a directory, an installed application, and an event.

12. The apparatus of claim 8, wherein the at least one processing device is configured to receive at least one of:
one or more names of one or more items to be searched for in the one or more devices or systems from the user through a graphical user interface; and
one or more locations where the one or more devices or systems are to be examined from the user through the graphical user interface.

13. The apparatus of claim 8, wherein the at least one processing device is configured to receive a frequency for which the one or more devices or systems are to be examined for the cyber-security risk.

14. The apparatus of claim 8, wherein the at least one processing device is configured to at least one of:
export the custom rule; and
import an additional custom rule.

15. A non-transitory computer readable medium containing instructions that, when executed by at least one processing device, cause the at least one processing device to:
obtain information defining a custom rule from a user, the custom rule associated with a cyber-security risk, the custom rule identifying a type of cyber-security risk associated with the custom rule and information to be used to discover whether the cyber-security risk is present in one or more devices or systems of an industrial process control and automation system;
provide information associated with the custom rule for collection of information related to the custom rule from the one or more devices or systems;
analyze the collected information related to the custom rule to identify at least one risk score associated with at least one of: the one or more devices or systems and the industrial process control and automation system; and
present the at least one risk score or information based on the at least one risk score.

16. The non-transitory computer readable medium of claim 15, wherein the instructions that when executed cause the at least one processing device to obtain the information defining the custom rule comprise:
instructions that when executed cause the at least one processing device to receive the type of cyber-security risk associated with the custom rule from the user through a graphical user interface.

17. The non-transitory computer readable medium of claim 16, wherein the instructions that when executed cause the at least one processing device to obtain the information defining the custom rule comprise:
instructions that when executed cause the at least one processing device to receive a classification, a risk source, and a discovery type from the user through the graphical user interface.

18. The non-transitory computer readable medium of claim 17, wherein:
the classification is one of a threat and a vulnerability;
the risk source is one of an endpoint and a network; and
the discovery type is one of a registry, a file, a directory, an installed application, and an event.

19. The non-transitory computer readable medium of claim 15, wherein the instructions that when executed cause the at least one processing device to obtain the information defining the custom rule comprise:
instructions that when executed cause the at least one processing device to receive at least one of:
one or more names of one or more items to be searched for in the one or more devices or systems from the user through a graphical user interface; and
one or more locations where the one or more devices or systems are to be examined from the user through the graphical user interface.

20. The non-transitory computer readable medium of claim 15, wherein the instructions that when executed cause the at least one processing device to obtain the information defining the custom rule comprise:
instructions that when executed cause the at least one processing device to receive a frequency for which the one or more devices or systems are to be examined for the cyber-security risk.
